(19) United States
(12) Patent Application Publication
(10) Pub. No.: US 2005/0282018 A1
(43) Pub. Date: Dec. 22, 2005

(54) Flame retardant composition

(75) Inventors: Hugues Van Den Bergen, Bruxelles (BE); Peter Lambrechts, Leest (BE)

Correspondence Address: WENDEROTH, LIND & PONACK, L.L.P., 2033 K STREET N. W., SUITE 800, WASHINGTON, DC, 20006-1021, US

(73) Assignee: DURFACE SPECIAL TIES S.A., BRUXELLES bELGIUM (BE)

(21) Appl. No.: 10/528,074

(22) PCT Filed: Oct. 13, 2003
(86) PCT No.: PCT/EP03/11294

§ 371 Date: Mar. 17, 2005

(30) Foreign Application Priority Data
Oct. 18, 2002 (EP) 02023363.1

(51) Int. Cl. B32B 17/00

(52) U.S. Cl. 428/426; 156/99; 522/96

(57) ABSTRACT

The present invention is directed to a method of producing a flame-retardant translucent laminate, comprising a translucent flame retardant, radiation cured layer bonding two sheets of glass. The starting composition of the layer comprises a radiation curable polymer precursor, especially an halogenated or phosphorous containing polymer precursor.

The invention relates to a reaction mixture for preparation of a fire resistant composition comprising a curable resin, and the reaction product of the mixture. Curable resins refer to polymer precursor having at least one ethylenically unsaturated group that can be polymerized i.e. cured. Polymerisation may be achieved by any suitable method. Preferred methods are thermal curing or irradiation, irradiation curing being often called radiation curing. The irradiation curing can be done for example by using ultraviolet radiation and/or ionising radiation, such as gamma rays, X-rays or an electron beam. The polymerization can be a free radical polymerization initiated by any free radical initiator, for example with photochemical initiators by radiation curing, or with chemical initiator.

The fire resistant compositions herein involved are compositions which are or which, after polymerization, can lead to compositions imparting and/or exhibiting resistance to attack, for example which are useful as flame-retardant compositions. Such compositions can delay the propagation of a fire for example by retarding the coming out of a flame.

There is a continuing need for new materials exhibiting an improved resistance to attack, for example improved flame retardants. Furthermore, there is a need for materials which, while possessing the above properties, are polymerisable, for example in the form of a coating, as a thin or thick layer.

Phosphorous containing materials can be used as flame retardants. It is believed that in the presence of a flame source they act by, for example, forming phosphoric and polyphosphoric acids of low volatility which catalyse the decomposition of organic compounds to carbon (char) and water. Non volatile phosphorous containing compounds may also coat the char to protect it from further oxidation, and this may act as a physical barrier and/or reduce the permeability of the char. It is believed that in general the greater the phosphorous content of the material the better its flame resistance.

It will be appreciated that the desire for imparting improved flame resistance by incorporating an increasing phosphorous content must also be balanced by the corresponding reduction in the proportion of other components in the treated or modified material. The overall physicochemical and mechanical properties of the resultant material must be maintained within limits acceptable for its end use. Preferably the polymers and polymer precursors of the invention are substantially free of halogen. The use of a halogen-containing monomer to prepare a flame-retardant composition is less desired. In fire, halogen groups can generate toxic and corrosive combustion products. These corrosive gases have toxic properties to living bodies. Moreover, these corrosive combustion products can cause significant damage to electronic components, present in particular in computers, which very often results in the loss of essential data and irreparable damage, often worse than the fire itself. The combustion products from halogen-containing materials may even be as dangerous as combustion products from materials untreated with flame-retardants. It is also undesirable to use halogen compounds for other reasons such as their potentially undesirable effect on the environment.

Many previous phosphorous containing flame retardants have been non-copolymerisable compounds and/or required additional halogenated compounds as additives to improve flame retardant properties. In conventional plastics, flame retardation of polymers has been achieved by the use of flame retardants as additives, which are physically blended as a mixture with the polymer. Such additives modify the physical and mechanical properties of the polymer often in an undesirable or unpredictable way. There may also be compatibility problems with the additive and the polymer to which it is added. Additives can also be unacceptable for certain applications, especially for coatings, as they can migrate through the coating to the surface which can lead to blooming phenomena. Additives may also discolour the composition which is a particular issue for clear coatings. Furthermore the use of certain additives may not work well with radiation curable materials since the high concentration of additives could lead to incomplete curing because the additive absorbs radiation.

For all these reasons, co-polymerisable compounds containing phosphorous have been developed in which the phosphorus atom is linked to the backbone of a polymer precursor through a chemical reaction in which a covalent bond is formed. This method of incorporating phosphorous is advantageous because as the phosphorous moieties are permanently linked to the backbone of the resultant polymer, there is no blooming effect and there are no compatibility issues as can be the case when incorporating phosphorous containing additives. Use of phosphorous containing polymer precursors also has a reduced influence upon the physical and mechanical properties of the resultant polymer. For example solid flame retardant additives can undesirably increase the viscosity of a polymer to which they are added.

Polyester (polymers) are compounds (usually polymer compounds) containing at least 2 ester functionalities.

Radiation-curable polymer precursors can be acrylated oligomers or monomers i.e. compounds containing radiation-curable acrylate functionalities.

Polyester acrylates (PEA) and polyester urethane acrylates (PEUA) represent an important class of radiation curable oligomer as they are often used as polymer precursors to make coatings (such as UV curable resins and UV curable powder coatings) for thermally sensitive substrates such as wood or MDF (medium density fiber).

Fire retarding curable polymer precursors can thus comprise halogenated or halogen-free, especially phosphorus containing, radiation curable polymer precursors.

U.S. Pat. No. 6,242,506 describes an halogenated radiation curable acrylic composition that is improved with regard to flame resistance by incorporating a reactive compound which is the reaction product of tetrabromophthalic anhydride or acid and a (meth)acrylic compound.

U.S. Pat. No. 5,456,984 describes an halogen-free radiation curable flame retardant composition that comprises an end-capped oligomer of a phosphonate polyol and a polyisocyanate and an organic monomer.

EP 1031574 describes a phosphorus polyol containing at least two terminal phosphate groups; or phosphonate groups; or one phosphate and one phosphonate group. Independent claims are also included for method for preparing said polyol; use of said polyol as additive in composition which is crosslinked by irradiation; oligomer obtained by reacting said polyol with polyisocyanate and hydroxylated acrylate; polymer obtained from said oligomer; and use of said polyol, polymer or oligomer in coatings or flame retardant compositions.

WO 0174826 describes a co-polymerisable phosphorus containing polymer precursor which comprises: a) a polymerisable unsaturated bond; b) an oxycarbonyl or iminocarbonyl group; and c) a free hydroxy group or a functional group obtainable by reaction of a free hydroxy group with a suitable electrophile; and d) a terminal phosphorus and oxygen containing group located at the end of a carbon chain and comprising at least one group selected from: hydroxy phosphorus and an optionally substituted hydrocarbyl group attached to a phosphorus atom through an oxy group. In an example, the reaction product of glycidyl methacrylate with dibutylphosphate (GMA-DBP) is used as polymer precursor.

EP1238997 describes an halogen-free radiation curable flame retardant composition that comprises an acrylated phosphorus containing polyol. An example is a phosphorous containing polyester acrylate.

The technique of laminating glass panes, i.e. bind two or more glass panes together in a permanent way by an interlayer, is well known and generally applied. Such glass laminates are used for automotive and building applications.

In the present description, the term “glass” is used to designate objects made of glass or of glass appearance. Glass appearance objects such as polycarbonate panels can be used but are less preferred because of their poor behavior in case of fire. The glass objects can be made of ordinary float glass, wether tempered or not, or of special glass such as borosilicate glass.

Laminating protects people for splinters in case of glass breaking, it also allows giving addition properties to the glazing. Basically, laminated glass is industrially produced either by a film system, or by liquid cast-in-place resin polymerised in situ. The film lamination technology often comprises the insertion of an organic, polymeric film between two glass panes, and bonding them at an elevated temperature under an elevated pressure. Different materials can be used, for example polyvinylbutyral (PVB) as the organic film. The foil is positioned on a glass pane, and a second pane positioned upon the film. The so-formed sandwich has to be passed through an oven, to weaken the film and create a preliminary adhesion. The sandwich has then to undergo a batch wise heating and pressure cycle, in order to bring the film in close contact with the glass and to develop adhesion onto the glass surfaces. This operation is done in an autoclave, at 120 to 135 (150) ° C. and with increased pressure, typically between 10 to 17 kg/cm², in order to bring the film in close contact with the glass and to develop adhesion onto the glass surfaces. Residence time in the autoclave at the required temperature is 30 to 45 minutes, longer for bent or multiple laminates. The total residence time, including heating and afterwards cooling is about 2 hours. The PVB film lamination process is described in ‘Encyclopedia of Chemical Technology’—KIRK-OTHMER—4^{th} edition, Volume 14, page 1059-1074. The main restrictions to this system are the high investment cost, whilst also the size of the autoclave can be restrictive in the case of larger panels and bent glazing. Moreover, the film lamination is batch wise, it requires a high-energy input. A large size apparatus is required, and the total operation time is long. Also, it's more difficult to apply on certain glass surfaces, e.g. toughened glass that is not completely flat. In such situations, the film is not elastic enough to adapt to the surface unevenness. Also for bent glass it's more critical to apply, when the curving of both glass panes wouldn't be identical. A possible solution to compensate for glass surface unevenness is to apply more film layers, 4 or 6 or more layers instead of 1 or 2 layers as standard used. However, in this way significantly more organic flammable material is incorporated. An alternative lamination technique is by the use of liquid resin, cured in situ. Two glass panes are bond together by a double-sided adhesive tape that also functions as a distance holder. The thus created cavity between the two sheets is then filled up with a liquid resin. Typically the envelope is positioned at an angle of some 45° during filling. After complete filling, the filling opening is closed with hot melt material and the filled sandwich tilted into horizontal position. The liquid resin is then polymerised, the so-called “curing”. Curing can be either by radiation, or chemically by appropriate catalysts and accelerators.

After completion of the polymerisation, the so-called “curing”, a solid interlayer is formed. There is basically no visual differentiation between foil laminated glazing and resin laminated glazing. The equipment needed for resin lamination is limited to one or two tilting tables to allow the assembly of the envelope, a dosing pump and, in case of radiation cure, an (UV) oven.

A strong technical advantage of the liquid resin system is that the cavity between the two glasses is completely filled up with the liquid resin, the shape or roughness of the glass surfaces is of no importance on the bonding with the resin interlayer. The incorporation of adhesion promoters(s), most often appropriate silanes, allows for a chemical bond to be created between the silanol (—Si —OH) functions on the glass surface, and the interlayer. A chemical bond is very strong and highly stable in time. The chemical nature of the liquid resins used for glass lamination can be of different kinds, either polyester, polyurethane, silicone or, most often nowadays, acrylic. The latter is preferred i.e. for its high resistance against outdoor weathering conditions, i.e. UV radiation, heat and humidity.

An example of a polyester based liquid resin system, for manufacturing acoustic glazing, is described in French patent 1367977, “Acoustic Laminates”, by SAINT-GOBAIN INDUSTRIES France.

An example of a urethane acrylate based liquid resin system, for manufacturing clear glazing, is given in EP0108631, by DELTAGLASS S. A., priority date 05.11.82. Curing of the liquid resin can be initiated either chemically, or by irradiation, UV or visible light radiation.

For chemical initiation one or more catalysts and an accelerator are added to the base resin, this is the so-called more-component system. Each of the above mentioned chemical types of resins could be more component.

The reaction starts after the blending of the catalyst(s) and the accelerator with the resin, after a period of time that depends on the resin composition, the concentrations of catalyst(s) and accelerator, and the temperature of the substrates and the environment.

Additionally, IR radiation sources can be applied to increase reaction speed. Radiation curable resins are initiated by irradiation. Nowadays mostly applied are UV resins, initiated by the action of UV light of low intensity. The UV radiation activates the reactive monomers of the system and starts the polymerization.

UV curable liquid resin systems are described in i.e. EP0108631.

UV resins are initiated by the action of UV light of low intensity. Typically, the residence time in the oven is 15 to 30 minutes.

Different chemical types of polymer precursors are possible, most applied are ethylenically unsaturated urethaneacrylate and acrylate based systems.

Acrylate based UV curable polymer precursors typically contain:
a reactive oligomer, i.e. an acrylated urethane oligomer,
reactive diluents, i.e. monomers,
the monomers can be one or more of the following: 2-ethylhexyl acrylate, 1,6-hexanediol diacrylate, n-hexyl acrylate, n-hexyl methacrylate, 2-hydroxyethyl acrylate, 2-hydroxyethyl methacrylate, isobornyl acrylate, isobornyl methacrylate, isooctyl acrylate, n-lauryl acrylate, n-lauryl methacrylate, methyl methacrylate (MAM), butyl acrylate, acrylic acid, methacrylic acid, isobutyl acrylate, cyclohexyl acrylate, 2-butoxyethyl acrylate, cyclohexyl acrylate, N-vinyl pyrrolidone, the preferred ones in the field of glass laminates are mono-functional monomers,
a photo-initiator,
adhesion promoters, for example silane compound
additives, as for example stabilisers.

Laminated glass is used in the automotive and the building industry. Its functions can be manifold, although the main objectives are sound insulation and safety and security performance.

Glazing in the building industry has several functions, more or less dependent on its application:
regulation of the in falling light and transparency, control of the in falling sun heath, integrity, protection against wind and heat, heat insulation,
acoustic insulation,
safety and/or security performances, to protect people against falling through glazing and against falling glass, to protect against burglary and vandalism,
decoration.

Traditional film or resin laminated glass fulfils most of these functions, in particular film or resin laminated glass may have very good properties as to sound reduction and impact resistance.

Laminated glass can have useful function in protection against fire. This is only obtained by the use of special glasses and/or special interlayers. Such interlayers are of a different chemical nature than the interlayers applied for standard glass lamination described above.

Typically, the interlayers, of organic or inorganic nature, for fire retardant glazing are as described in the publications mentioned herebelow:

EP0500317 from PILKINGTON PLC (GB) describes a reaction mixture for preparation of a fire resistant composition comprising an epoxy resin, a curing agent for said resin and a boron compound which is not a curing agent for the epoxy resin, the reaction mixture being translucent such that the reaction mixture cures to a translucent reaction product. The invention further provides a method of producing a fire resistant laminate in which the cured reaction product of a boron compound containing epoxy resin is used as an interlayer between two translucent panes and a translucent fire resistant laminate. The processing time is long and the pot life of the epoxy resin is relatively shore

WO 99/15604 (PILKINGTON PLC) describes an interlayer material for fire resistant laminates comprising a water soluble, glass forming metal phosphate, a water soluble char forming component and a binding agent. A starting formulation contains 70 parts metal phosphate, 20 parts sorbitol, 10 parts boric acid and 10 parts of 60% acrylamid solution.

WO 0170495 PILKINGTON PLC describes waterglass based intumescent interlayer and methods for the production of such laminates. These laminates are produced by pouring an aqueous waterglass solution onto the surface of a first glass pane and drying the solution in such a manner that a clear interlayer is formed. The processing time is long.

WO 0119608 (GLAVERBEL) describes transparent fire break glass panels comprising at least two glass sheets and an intumescent phosphate-based material layer, which layer is located between said two glass sheets. The intumescent material comprises pyrogenous silica or a mixture of pyrogenous silica and alumina. The manufacture of such laminates includes a lengthy and delicate step of drying the intumescent material.

A need exists to develop fire retardant glazing that can be fast processed using flame retardant compositions that can be cured in a very short time, without water or solvent evaporation.

A need exists to develop compositions which are (or can produce, after cure) translucid (and, more preferably transparent), flame-retardant and adherent to glass, and of easy curing.

A need exists to produce in an efficient way translucent laminates combining together improved flame retardancy property with high impact resistance, acoustic insulation, aging resistance, adhesion on laminates or more of one of these properties.

The present invention provides a reaction mixture for preparation of a fire resistant composition comprising a curable flame retardant polymer precursor, and may also contain flame retardant additives such as intumescent agents and flame retardant organic or inorganic additives, the reaction mixture being such that the reaction mixture cures to a translucent reaction product.

The present invention provides a radiation curable composition comprising:
(i) at least one radiation curable polymer precursor providing flame retardant properties to the cured composition (“flame retardant polymer precursor”), which polymer precursor comprises one or more radiation polymerizable, halogen or phosphorus containing (or combination of both) polymer precursor which have, at the chains ends or laterally along the chain, acrylic, methacrylic or vinyl groups, and
(ii) at least one of the following compounds:
(ii1) a radiation curable monomer which is a monoethylenically or polyethylenically unsaturated monomer (“non flame retardant monomer”) and/or
(ii2) a radiation curable monomer which is an halogen or phosphorus containing (or combination of both) reactive monomer which contributes to flame retardant properties of the cured composition (“flame retardant monomer”).

The present invention provides a reaction mixture for preparation of a fire resistant composition comprising a curable non flame retardant polymer precursors and flame retardant additives such as intumescent agents, flame retardant organic additives, flame retardant inorganic additives, or combination thereof, the reaction mixture being such that the reaction mixture cures to a translucent reaction product. The present invention provides a reaction mixture for preparation of a fire resistant composition comprising a mixture of curable flame retardant polymer precursor with a curable non flame retardant polymer precursors, and may also contain intumescent agents and flame retardant organic or inorganic additives, the reaction mixture being such that the reaction mixture cures to a translucent reaction product.

Such mixture permits to develop flame retardant resins that can be cured in a very short time, without water or solvent evaporation, useful in glass laminates manufacture.

The compositions are (or can produce, after cure) translucid (and, more preferably transparent), flame-retardant and adherent to glass, and of fast and easy curing upon appropriate irradiation.

Translucent laminates can be produced combining together improved flame retardancy property with high impact resistance, acoustic insulation, aging resistance, adhesion on laminates or more of one of these properties. The present invention provides a method of producing a flame-retardant translucent laminate, the method comprising:
(i) providing a radiation curable composition comprising at least one radiation curable polymer precursor having polymerizable ethylenically unsaturated functions (component I) and an optional additive (component II), at least one of the components providing flame retardant properties to the cured composition,
(ii) curing the polymer precursor preferably by irradiating the composition and
(iii) forming a layer which layer comprises the cured composition and bonds at least two glass panes so as to form a flame-retardant translucent laminate.

The present invention also provides a method of producing a translucent fire resistant laminate comprising the steps of: providing a reaction mixture comprising a flame retardant curable polymer precursor, a free radical initiator for said resin and flame retardant additives; and let the reaction mixture cure to form a translucent reaction product which forms an interlayer between two translucent panes.

The steps (i), (ii) and (iii) involved into the claimed method are not necessarily distinct, successive, separated steps. For example, and in a preferred embodiment, the curable composition can be placed between the glass sheets, allowed to cure by irradiation under UV-light, so as to form a glass laminate comprising a cured composition layer (“interlayer”) bonding the glass sheets together.

It has been observed that a radiation curable composition comprising a flame-retardant component permits to bond two glass sheets together and to form a glass laminate presenting an advantageous combination of properties sought after for safety/security glass laminates with flame-retardant/fire resistant properties desired for flame retardant laminates.

Preferred embodiments of the invention are described in the claims.

Polymer precursors may comprise one or more monomer, oligomer, polymer and/or mixtures thereof which have suitable polymerisable functionality.

A monomer is a polymerisable compound with a low molecular weight (e.g. <1000 g/mol). An oligomer is a polymerizable compound of intermediate molecular weight, higher than a monomer. Preferably, the molecular weight of an oligomer is comprised between about 250 and about 4,000 daltons. A monomer is generally a substantially monodisperse compound whereas an oligomer or a polymer is a polydisperse mixture of compounds. A polydisperse mixture of compounds prepared by a polymerisation method is a polymer.

The generic term resin is commonly used to designate a polymer precursor. Flame retardant additives are defined as non reactive (organic or inorganic) additives, i.e. the additives are not co-polymerizable by actinic irradiation, heat, or chemical cure. In the present invention, the flame retardant additives are preferably compatible with the other components of the reaction mixture in such a way that the reaction mixture cures to a translucent reaction product.

The role of organic or inorganic additives is to increase the flame retardancy properties.

Examples of flame retardant organic additives and their mechanism of action are described in “Fire Retardancy of Polymer Materials”, edited by Arthur F. Grand & Charles A. Wilkie; Marcel Dekker Inc (2000), pages pages 245 to 279 (halogen based), pages 147 to 168 (phosphorus based), pages 353 to 387 (silicon based). Examples of flame retardant inorganic additives are boron, zinc, iron, antimony derivatives as described in “Fire Retardancy of Polymer Materials”, edited by Arthur F. Grand & Charles A. Wilkie; Marcel Dekker Inc (2000), pages 119 to 134 and pages 327 to 335.

The role of intumescent agents is to increase the duration of fire resistance. Examples of intumescent agents are organic substances generally in the form of polyhydric compounds, the term “polyhydric” being here used to denote organic compounds having two or more hydroxy groups. These compounds can also be referred to as polyols and include trimethylolpropane and its derivatives, pentaerythritol and its derivatives, the glycols, glycerine and its derivatives and the sugars. The polyhydric compounds can be used individually or in mixtures or combinations. Gas generator can also be used alone or in combination with the polyhydric compounds to blow the forming char to a porous product. This surface char insulates the substrate from the flame, heat and oxygen. Examples of intumescent agents and their mechanism of action are described in “Fire Retardancy of Polymer Materials”, edited by Arthur F. Grand & Charles A. Wilkie; Marcel Dekker Inc (2000), pages 150-153, pages 217-236. Preferred reaction mixtures leading to translucent reaction products in accordance with the invention have a light transmission, through a 2 mm layer thereof, of at least 10%, preferably at least 50%, more preferably a least 80%. The reaction product is preferably transparent wether colored or not.

The radiation curable compositions according to the invention generally comprise a photochemical initiator and/or a chemical initiator. Photochemical initiators (also called photoinitiators) are compounds that can generate radicals by absorption of light, typically UV light. Typical photochemical initiators are described in “The chemistry of free radical polymerization”, edited by Graeme Moad and David H. Solomon; Pergamon (1995), pages 84 to 89. Alternatively, the same composition without photoinitiator can be cured by electron beam (EB). Chemical initiators are typically azo-compounds or peroxides that are decomposed to radicals through the application of heat, light or a redox process. The mechanisms are described in “The chemistry of free radical polymerization”, edited by Graeme Moad and David H. Solomon; Pergamon (1995), pages 53-95.

The radiation curable composition according to the invention preferably contains one or more radiation curable halogen or phosphorus based (or combination of both) oligomers, the molecular weight of which is generally lower than 10,000 and which have, at the chains ends or laterally along the chain, acrylic, methacrylic or vinyl groups. Examples of such flame retardant mono- or polyethylenically unsaturated oligomers are phosphorus based urethane acrylates or methacrylates, such as described in U.S. Pat. No. 5,456,984 and EP 1031574, EP1238997, EP1238997, phosphorus based polyester acrylates or methacrylates, such as described in EP1238997, halogenated epoxyacrylates such as describes in U.S. Pat. No. 6,242,506, and the like. Water-thinnable phosphorous-containing polyesteracrylates or methacrylates can also be used. These can be prepared from polymer precursor described in EP1238997 by hydrolysis of their phosphinate ester (P—O—C) bonds.

The radiation curable composition according to the invention preferably contains one or more monoethylenically or polyethylenically unsaturated flame retardant monomers that are halogen, phosphorus and/or boron based based.

These flame retardant monomers generally enable to adjust the viscosity depending on the intended industrial application and to confer flame retardancy properties. The monomers have molecular weight typically lower than 1500 daltons. Since these monomers contain radiation curable ethylenically unsaturated groups, for example, acrylic groups, they also participate in the radiation curing, and after polymerization, they are permanently part of the final polymeric products obtained.

Examples of suitable flame retardant monoethylenically or polyethylenically unsaturated flame retardant monomers are phosphate esters mentioned in prior art content of WO 0174826, phosphate esters available in commerce from UCB with trade name Ebecryl 168 and Ebecryl 170, phosphate esters available in commerce from Rhodia with trade names PAM-100 and PAM-200 (methacrylated phosphonated esters). Example of halogen containing monomers is pentabromobenzylacrylate (for example available in commerce from Dead Sea Bromine Group under the tradename FR-1025 M)

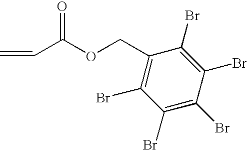

Another example of boron containing monomer is: 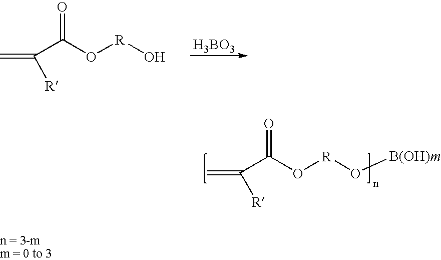
or hydroxyethyacrylate reacted with boric acid:

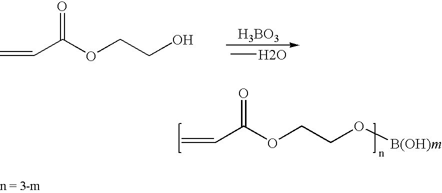

Another preferred monomer is the reaction product of glycydilmethacrylate with dialkylphosphate or the same reacted with boric acid
R=alkyl, preferably butyl

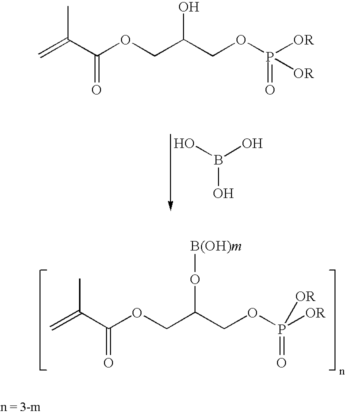

When m is different from 0, the obtained compound can be further reacted, for example with a polyol.

The flame retardant radiation curable composition may also contain:
one or more non flame retardant curable oligomers, and/or
one or more non flame retardant monoethylenically or polyethylenically unsaturated monomers, such as acrylic acid, methacrylic acid, beta-carboxyethyl acrylate, butylacrylate, butylmethacrylate, methylacrylate, methylmethacrylate, 2-ethylhexylacrylate, 2-ethylhexymethacrylate, acrylic acid, methacrylic acid, octyl/decyl acrylate, octyl/decyl methacrylate, 2-hydroxyethylacrylate, 2-hydroxyethylmethacrylate, phenoxyethylacrylate, phenoxyethylmethacrylate, nonylphenolethoxylate monoacrylate, nonylphenolethoxylate monomethacrylate, beta-carbonylethylacrylate, 2-(-2-ethoxyethoxy)ethylacrylate, 1,6-hexanediol diacrylate (HDDA), pentaerythritoltriacrylate (PETIA), trimethylolpropanetriacrylate (TMPTA), acrylated or methacrylated oxyethylated or/and oxypropylated derivatives. The flame retardant radiation curable composition should be translucent when a translucent product is required i.e. as the interlayer of a fire-resistant laminate to be used as a window. Mixtures of these monoethylenically or polyethylenically unsaturated polymer precursor may be used in accordance with the invention. The photoinitiator is capable of initiating the polymerisation by exposure to actinic radiation, like UV radiation. Typically about 0.2% by weight of a photoinitiator is used, if the composition has to be polymerised by exposure to UV radiation. Preferably, the amount of photoinitiator in the composition is comprised between 0.01 and 3%.

The flame retardant radiation curable compositions generally contain at least 30 parts by weight of the flame retardant radiation curable resin, preferably at least 50 parts by weight and more preferably at least 60 parts by weight.

According to a preferred embodiment of the invention the radiation curable compositions comprises also a non-reactive (non co-polymerizable) flame retardant additive.

Flame retardant organic or inorganic additives which may be incorporated in the fire retardant reaction mixtures of the present invention include phosphorus based compounds as phosphates, phosphonates, phosphites, oligomeric phosphorus compounds, also halogenated, usually chlorinated, compounds, bore derivatives, zinc derivatives, silica derivatives. Nanoparticules like silica nanoparticules or nanoclays (organo-modified or not) may also be used. The very low particule size of the nanoparticules (nm range) allows improved transparency compared to other inorganic additives (micrometer range). Nanoclays confer flame retardancy by acting as a insulator and mass-transport barrier, slowing the escape of the volatile products generated by the decomposition of the product. The patent application PCT/EP02/07371 filed on Mar. 7, 2002 describes radiation curable composite compositions comprising polymers with mineral materials. Such compositions are suitable for forming coatings. The coatings and/or compositions described preferably comprise nano-sized minerals, preferably comprising nano-layers, called nanoclays when the nano-layer minerals are clays.

Examples of suitable organic additives include organic phosphorous containing compounds such as tris-(2-chloroethyl) phosphate, diphenyl phosphite, dibutyl phosphite, ammonium phosphates, ammonium polyphosphates, melamine phosphates (e.g. melamine pyrophosphate and/or melamine orthophosphate), 9, 10-dihydro-9-oxa-10-phosphaphenantrene-10-oxide (DOPO), pentaerythritol phosphates, polyphosphazene derivatives, tris-2-chloroethyl phosphate (TCEP), tris(dichloroisopropyl) phosphate (TDCP), tris(monochloroisopropyl) phosphate, tributoxyethyl phosphate, trioctyl phosphate, triphenylphosphate, diphenyl chlorophosphate, chlorinated diphosphate esters, available in commerce from Rhodia as ANTIBLAZE V 66 (chlorinated diphosphate esters) and V 88 (chlorinated diphosphate esters). Phosphonates e.g. Rhodia's ABLAZE DMMP, dimethyl methyl phosphonate, or Fyrol 6 (diethyl N,N bis(2-hydroxyethyl)aminomethylphosphonate) from Akzo Nobel may also be used. Cyclic phosphonate esters available in commerce from Rhodia as Antiblaze CU (cyclic phosphonate esters) and Antiblaze 1045 (cyclic phosphonate esters) may be used. Halogen-free polymeric phosphorus derivative available in commerce from Albermarle under the trade name Ncendex P-30 (propriatory halogen-free, phosphorus-based flame retardant) may be used. Oligomeric phosphate esters like Fyrol 51 (oligomeric phosphate ester) and Fyrol 99 (oligomeric phosphate ester) from Akzo Nobel may be used. Examples of suitable halogenated compounds include liquid chloroparaffins, such as that available from Hoechst Chemicals as HOECHST 40 LV. Examples of boron organic or inorganic derivatives are boric acid (inorganic) and trimethoxyboroxine (organic). Boron derivatives are believe to be converted in inorganic borates which combine at high temperature to form glassy polyborates which impregnate the residual char to impart good mechanical stability and improve the adhesion between the impregnated char and the surface of the glass. Examples of suitable inorganic additives include inorganic phosphorous containing compounds such as ammonium phosphates, ammonium polyphosphates, inorganic hydroxides such as aluminium trihydroxide, magnesium hydroxide, brucite, hydromagnesite, aluminium phosphinates, mixed metal hydroxides and/or mixed metal hydroxycarbonates; inorganic oxides such as magnesium oxide; and/or antimony trioxide; silicone, silica and/or silicate derivatives; and/or other inorganic materials such as magnesium calcium carbonate, barium metaborate; zinc borate, zinc hydroxystannate; zinc stannate; zinc metaborate; expandable graphite; and/or blends of vitreous materials that act as a flame retardant barrier (such as that available from

Ceepree under the trade name Ceepree 200).

Examples of suitable inorganic additives include nanoparticules. Examples of nanoparticules are available from Hanse Chemie with the trade name Nanocryl (nanosilica reinforced acrylate), available from Hybrid Plastics™ with the trade name POSS™ (polyhedral oligomeric silsesquioxanes), available from Degussa with the trade name Aerosil (fumed silica), available from Süd-Chemie with the trade name Nanofil (nanoclays).

The flame retardant additives may optionally be surface treated to improve their compatibility with the polymers to which they are added. For example inorganic hydroxides may be surface treated with long chain carboxylic acid (s) and/or silane (s) as described in “Fire Retardancy of Polymer Materials”, edited by Arthur F. Grand & Charles A. Wilde; Marcel Dekker Inc (2000), pages 285 to 352.

According to another preferred embodiment the radiation curable composition comprises also a reactive co-polymerizable flame-retardant additive, especially nano particles such as described here-above functionalized with acrylate and/or methacrylate functions.

When the reaction mixture is to be used in the production of a translucent laminate, it may be “cast” in a casting cell comprising two opposed outer plies, e.g. of glass or plastics spaced apart and separated from one another by a peripheral spacer between them, and cured in the cell. Such techniques are well known and are described in, for example, GB-A-2015417 and GB-A-2032844, and in EP-A-0200394.

The glass plies may for example be of annealed (float) glass, toughened (heat or chemically toughened) glass, ceramic glass or borosilicate glass and the plastics plies may be of acrylic or polycarbonate plastics material.

The laminate made of two glass sheets bonded with an interlayer according to the invention, can be a part of window assemblies such as for example multi-sheets laminate, comprising several laminates bound to each other with an interlayer, each interlayer being of the same or different composition, flame retardant or not, but at least one interlayer being of the present invention.

The term “translucent” is used herein to describe products and materials which transmit light so that they are suitable for glazing applications, whether providing clear through vision, i.e. being transparent or colorless, or not.

### EXAMPLES 1 to 19

Experimental Conditions

In all examples, the experimental conditions were as follows:

Glass Laminate Assembly

Two glass panes, normal float 4 mm nominal thickness, are bound together with double-sided tape 3M VHB4910. Liquid resin composition is introduced in the interspace using a funnel. Curing is made in a conventional UV oven, intensity measured on the interlayer is 1.5-2.5 mW/cm². Curing time is 20-25 minutes. Resin laminates coded as 4/1/4 means: 4 mm float glass—1 mm resin interlayer (I.L.)—4 mm float glass.

Resin Color

measured on the 1 cm thick resin as is, on LOVIBOND PFX190—TINTON SERIES II apparatus, in APHA scale.

Thermal Stability of the Resin

the resin sample is stored at 50° C. for a prolonged period of time, and changes in color are reported (delta E).

Shore Hardness of the Cured Resin

shore hardness is a measure of the hardness of a resin interlayer after cure.

It is measured by SHORE DUROMETER on a sample of 10 mm thickness, cured as described in 1−. The level of penetration of a needle into the surface of the sample is measured and expressed as a value between 100 and 0. Lower figures indicate deeper penetration and softer products.

Adhesion of the Interlayer on the Glass Surface

is measured as a shear adhesion on 20*20 mm samples cut from a laminate, 24 hours after cure. The apparatus used is: LHOMARGY DY31 dynamometer, drawing speed 10 cm/min,

shear adhesion is measured at rupture, reported in MPa, megapascal, the elongation at rupture is reported in mm.

Laminate—Visual Appearance of

Inspected for mechanical and optical defects, transparency, visual coloration.

Laminate—Color

measured on BYK GARDNER COLORSPHERE, reported in CIELab system as L*, a*, b*.

Laminate—Klima Testing

In the Klima test, the samples are subjected to cyclic changes in temperature, between −30 and +80° C. This is a measure of the resistance of the glazing against thermal chocs.

In these tests, duration was 100 cycles of 4 hours each.

Laminate—Thermal Ageing

The laminate is stored at 50° C. for a prolonged period of time and changes in colour are reported.

color is measured on BYK GARDNER COLORSPHERE, reported in CIELab system as L*, a*, b*

eventual changes in color are reported as DELTA E values.

Interlayer—Behavior in Fire Conditions

Free interlayer films, i.e. not bound on glass surfaces, can be visually observed for their behavior in flame conditions. In real life, the interlayer is between glass sheets. However, when the glass breaks, the interlayer comes in direct contact with the flames. A similar situation as will occur when the glass is broken, is simulated in this test.

In this test, a free film is positioned horizontally and fire is set by a lighter. It's visually observed how the material behaves, as to burning and speed of burning, smoke development, charring.

This test is not quantitative, but allows comparison with (a) reference(s).

Laminate—Behavior in Fire Conditions

Cone Calorimeter

10 cm×10 cm samples of glass laminate (4/1/4) with references 1, 2, 3, 4, 5, 6 and 7 were tested in a cone calorimeter equipment (as described in standard ISO 5660) at a flux level of 50 kWm⁻²) where the rate of heat release (in kWm⁻²) was recorded as a function of time, as well as the total of heat release (kJ/m2) and the peak of heat release (kW/m2).

Glass laminate 1 and 2 are non flame retardant laminates. Glass laminate 3 to 19 are flame retardant laminates based on the different approaches of the present invention. A strong reduction in the Total of heat release (kJ/m2) and a strong reduction in the Peak of heat release (kW/m2) for the glass laminates 3,4,5,6 and 7 is observed compared to the non flame retardant glass laminates references 1 and 2. This shows that glass laminate systems 3, 4, 5, 6 and 7 can be considered as having improved flame retardancy compared to glass laminates 1 and 2.

| Glass | | | | | | Char | |
|---|---|---|---|---|---|---|---|
| laminate | | Total of | Peak of | Char | Char | residue | |
| (cone) or | | heat | heat | residue | residue | 800° C. or | |
| film | Resin | release | release | 600° C. (air) | 700° C. (air) | 850° C. (air) | |
| (TGA) | composition | (kJ/m2) | (kW/m2) | or (N₂) | or (N₂) | or (N₂) | Followed approach |
| 1 | Uvekol A | 26.2 | 442 | 0.81 (air) | 0.66 (air) | 0.75 (air) | non flame retardant curable resin |
| | | | | 4.1 (N₂) | 4.0 (N₂) | 4.0 (N₂) | |
| | | | | | | 800° C. | |
| 2 | Uvekol S | 27.6 | 392 | 0.43 (air) | 0.31 (air) | 0.37 (air) | non flame retardant curable resin |
| | | | | 1.1 (N₂) | 1.1 (N₂) | 1.1 (N₂) | |
| | | | | | | 800° C. | |
| 3 | Raylok 1722 (60) | 16.9 | 265 | 5.7 (air) | 4.1 (air) | 2.7 (air) | flame retardant curable resin in |
| | MAM (40) | | | | | 800° C. | combination with non flame |
| | Irgacure 184 (0.2) | | | | | | retardant curable monomer |
| 4 | Raylok 1722 (75) | 17.0 | 304 | | | | flame retardant curable resin in |
| | MAM (25) | | | | | | combination with non flame |
| | Irgacure 184 (0.2) | | | | | | retardant curable monomer |
| 5 | Uvekol A (60) | 17.9 | 300 | 18.3 (N₂) | 17.7 (N₂) | 15.8 (N₂) | non flame retardant curable resin |
| | GMA-DBP (40) | | | | | 800° C. | in combination with flame |
| | Irgacure 184 | | | | | | retardant curable monomer |
| | (0.12) | | | | | | |
| 6 | Uvekol S (80) | 21.3 | 365 | Not | Not | Not | non flame retardant curable resin |
| | Ncendx P-30 (20) | | | measured | measured | measured | in combination with flame |
| | | | | | | | retardant organic additive |
| 7 | Uvekol A (100) | 20.9 | 250 | Not | Not | Not | non flame retardant curable resin |
| | Cloisite 30B (5) | | | measured | measured | measured | in combination with flame |
| | | | | | | | retardant inorganic additive |
| | | | | | | | (nanoclays) |
| 8 | Raylok 1722 (60) | Not | Not | 20.0 (air) | 8.1 (air) | 2.8 (air) | flame retardant curable resin in |
| | GMA-DBP (40) | measured | measured | 17.9 (N₂) | 17.3 (N₂) | 15.3 (N₂) | combination with flame retardant |
| | | | | | | 800° C. | curable monomer |
| 9 | Raylok 1722 (50) | Not | Not | 15.6 (air) | 10.6 (air) | 3.2 (air) | flame retardant curable resin in |
| | Ncendx P-30 (20) | measured | measured | 10.9 (N₂) | 10.6 (N₂) | 9.9 (N₂) | combination with flame retardant |
| | HDDA (25) | | | | | 800° C. | organic additive and non flame |
| | | | | | | | retardant curable monomer |
| 10 | Raylok 1722 (80) | Not | Not | 19.5 (N₂) | 19.4 (N₂) | 19.2 (N₂) | flame retardant curable resin in |
| | XP 21/768 (40) | measured | measured | | | 800° C. | combination with flame retardant |
| | | | | | | | organic additive |
| 11 | GMA-DBP (100) | Not | Not | 27.3 (air) | 16.1 (air) | 4.0 (air) | flame retardant curable monomer |
| | | measured | measured | 27.4 (N₂) | 26.4 (N₂) | 20.2 (N₂) | |
| | | | | | | 850° C. | |
| 12 | GMA-DBP | Not | Not | 32.37 (air) | 22.62 (air) | 10.49 (air) | flame retardant curable monomer |
| | reacted with boric | measured | measured | 30.52 (N₂) | 29.88 (N₂) | 26.06 (N₂) | containing boron with non flame |
| | acid (1 mol/0.33 mol) | | | | | 850° C. | retardant monomer |
| | (90) | | | | | | |
| | MAM (10) | | | | | | |
| 13 | Eb 600 (60) GMA- | Not | Not | 14.8 (air) | 2.7 (air) | 2.5 (air) | flame retardant curable resin in |
| | DBP (20) MAM | measured | measured | 25.3 (N₂) | 24.5 (N₂) | 22.7 (N₂) | combination with flame retardant |
| | (20) | | | | | 850° C. | curable monomer |
| 14 | Eb 600 (60) | Not | Not | 28.5 (air) | 11.1 (air) | 9.8 (air) | flame retardant curable resin in |
| | Ebecryl 168 (20) | measured | measured | 28.3 (N₂) | 27.3 (N₂) | 24.8 (N₂) | combination with flame retardant |
| | MAM (20) | | | | | 850° C. | curable monomer |
| 16 | GMA-DBP (80) | Not | Not | 22.0 (air) | 21.1 (air) | 19.4 (air) | flame retardant curable monomer |
| | Eb 350 (20) | measured | measured | 25.9 (N₂) | 25.4 (N₂) | 22.0 (N₂) | in combination with silicone |
| | | | | | | 850° C. | acrylate |
| 17 | GMA-DBP (90) | Not | Not | 34.5 (air) | 25.5 (air) | 20.0 (air) | flame retardant curable monomer |
| | trimethoxyboroxine | measured | measured | 32.1 (N₂) | 31.6 (N₂) | 29.0 (N₂) | in combination with boron |
| | (10) | | | | | 850° C. | derivative |
| 18 | GMA-DBP with | Not | Not | 63.3 (air) | 57.3 (air) | 55.7 (air) | flame retardant curable monomer |
| | 50 wt % SiO2 | measured | measured | 62.2 (N₂) | 61.8 (N₂) | 59.1 (N₂) | in combination with acrylated SiO2 |
| | nanoparticule | | | | | 850° C. | nanoparticule |
| 19 | Raylok 1722 (36) | Not | Not | 34.0 (air) | 32.7 (air) | 32.7 (air) | flame retardant curable resin in |
| | GMA-DBP with | measured | measured | | | 850° C. | combination with flame retardant |
| | 50 wt % SiO2 (36) | | | | | | curable monomer and acrylated |
| | MAM (28) | | | | | | SiO2 nanoparticule |

‘Epiradiateur’ is a test method to evaluate the inflammability of building materials, to evaluate to what level the testmaterial can contribute to (the start of) a fire.

The test sample, 400*300 mm is positioned under an angle of 45°, the side to be tested downwards, into a test cabinet with controlled air inlet. The sample is exposed to an electrical radiator as the heat source, with heat flux 30 kW/m². The heat source is positioned under the test sample, parallel to it. (Pilot lights can be installed too, in order to detect and burn released gasses.)

The test is standard run for 20 minutes, it can be extended where required. Important parameters are:
i=inflammability, speed
   i=(1000/15*t1)+(1,000/15*t2)
   t1=moment the flame starts at the bottom side
   t2=moment the flame stops
at the bottom side
   t1′=moment the flame starts at the top side
   t2′=moment the flame stops at the top side
s=flame development
   s=sum(hi)/140
h=index for maximal flame height
   h=hMAX/20
c=index voor inflammability, heat development
   c=S/120 with S the surface under the temperature curve (t°=f(time))

Q=sum (hi*100)/t1*square root (t2−t1)

| laminate | t1 | t2 | t1 − t2 | | h | Q |
|---|---|---|---|---|---|---|
| 1 | 558 | 971 | 413 | 6′53″ | 0.75 | 0.93 |
| 2 | 343 | 920 | 577 | 9′37″ | 0.60 | 1.35 |
| 3 | 389 | 1115 | 726 | 12′06″ | 0.30 | 0.89 |
| 11 | 260 | 954 | 694 | 11′34″ | 0.45 | 0.57 |
| 12 | 223 | 964 | 741 | 12′21″ | 0.15 | 0.15 |
| 19 | 308 | 617 | 309 | 5′07″ | 0.15 | 0.25 |

Uvekol™ A (liquid resin cast between sheets of glass and cured under UV light to produce sound insulating glass laminate), Uvekol™ S (liquid resin cast between sheets of glass and cured under UV light to produce sound insulating and impact resistant glass laminate) are products available from UCB.

Raylok™ 1722 is an acrylated phosphorous containing UV curable oligomer available from UCB. Its preparation is covered by patent file application WO 02/070587.

Eb 350, Eb 168, Eb 170 and Eb 600 are UV curable oligomer acrylate available from UCB.

Irgacure 184 is a photoinitiator available from Ciba.

GMA-DBP refers to the reaction product of glycidylmethacrylate with dibutylphosphate. Its preparation is described in WO 0174826 (example 1, la).

XP 21/768 was purschased from Hanse Chemie (HDDA with 50 wt. % silica nanoparticule)

NcendX P-30 (organophosphate) was purschased from Albemarle

The bentonite clay available commercially from Southern Clay under the trade name Cloisite 30B comprising an organoammonium cation of formula: 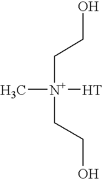
where HT denotes a hydrogenated tallow residue (˜65% C18; ˜30% C16; —5% C14).

The GMA-DBP reacted with boric acid used in example 12 was prepared as follows: To a 1.5 litter double jacketed reactor vessel connected to an oil bath and equipped with a stirrer, was added 341 g (0.90 mol) of the phosphorus containing reactive methacrylate (GMA-DBP), 19 g of boric acid (0.30 mol), 359 g of toluene; 1.08 g of 4-methoxyphenol (mono methylether hydroquinone or MEH9—an antioxidant) wa added and the reaction mixture was stirred and heated under reflux and air sparge until no more water is distilled (6 g). 0.42 g of MeHQ was added, and toluene was stripped under air sparge and vacuum, after which the product was cooled at room temperature and drummed off.

Stability, Color, Adhesion Properties

Glass Laminate 3

The resin used in laminate 3 is characterized by low color (162 Apha), excellent stability and homogeneity (no decantation), workability and reactivity. The laminate 3 has excellent transparency (transmittance>85%), excellent optical properties (no optical defects), is stable against temperature and LW irradiation (no yellowing).

Shear adhesion is outstanding (9.25 MPa) compared to non flame retardant laminates 1 (2-2.5 MPa) and 2 (5 to 7 MPa).

Glass Laminate 5

The resin used in laminate 5 is characterized by low color (<20 Apha), excellent stability and homogeneity (no decantation), workability and reactivity.

The laminate 5 has excellent transparency (light transmission>85%), optical properties (no optical defects), is stable against temperature and UV irradiation (low yellowing).

The shear adhesion on glass is higher (>5 MPa) than non flame retardant laminate 1 (shear adhesion 2 to 2.5 MPa).

Thermogravimetric Analysis (TGA)

Films preparation: to the compositions, were added a Irgacure (5 parts) and amine synergist Eb 7100 (5 parts). The formulations were applied to a glass substrate with a bar coater and cured by UV radiation (120 W/cm, Hg lamp) under nitrogen, 5 m/min to form a film of 100 micron thickness. The cured films were peeled off from the glass substrate and were further tested by thermogravimetric analysis.

Films 1, 2, 3, 5, 8, 9, 10, 11, 12, 13, 14, 15, 16, 17, 18 and 19 and 11 were submitted to a TGA in which the samples were heated at a rate of 10° C./min under air or nitrogen (N₂) atmosphere from room temperature up to 800° C. (or 850° C.). The weight % residues at 600° C., 700° C. and 800° C. (or 8500C)in the TGA test described herein for the films of the invention (films 3, 5, 8, 9, 10, 11, 12, 13, 14, 15, 16, 17, 18 and 19) were compared with two films made from a prior art (1 and 2). At a given temperature, a higher char yield indicated that the material is a better flame retardant.

As can been seen, the char residues at 600° C., 700° C. and 800° C. under air or/and nitrogen of films 3, 5, 8, 9, 10, 11, 12, 13, 14, 15, 16, 17, 18 and 19 are significantly higher than for comparative example 1 and 2 (prior art), illustrating the improved flame-retardant properties of the films of the invention.

Klima testing

| Glass laminate | Kima test 100 cycles |
|---|---|
| 13 | passed |
| 14 | passed |
| 19 | passed |

1. A method of producing a flame-retardant translucent laminate, the method comprising:
(i) providing a radiation curable composition comprising at least one radiation curable polymer precursor having polymerizable ethylenically unsaturated functions (component I) and an optional additive (component II), at least one of the components providing flame retardant properties to the cured composition,
(ii) curing the polymer precursor preferably by irradiating the composition and
(iii) forming a layer which layer comprises the cured composition and bonds at least two glass panes so as to form a flame-retardant translucent laminate.

2. A method of producing a flame-retardant translucent laminate according to claim 1, wherein the radiation curable polymer precursor provides flame retardant properties to the cured composition (“flame retardant polymer precursor”).

3. A method of producing a flame-retardant translucent laminate according to claim 2, wherein the flame retardant polymer precursor comprises one or more radiation curable halogen or phosphorus containing (or combination of both) polymer precursor which have, at the chains ends or laterally along the chain, acrylic, methacrylic or vinyl groups.

4. A method of producing a flame-retardant translucent laminate according to claim 3, wherein the flame retardant polymer precursor comprises at least one of: phosphorus containing urethane acrylate or methacrylate, phosphorus containing polyester acrylate or methacrylate, phosphorus containing epoxy acrylate or methacrylate.

5. A method of producing a flame-retardant translucent laminate according to claim 1, wherein the composition contains one or more radiation curable monomer which is an halogen or phosphorus containing (or combination of both) reactive monomer which contributes flame retardant properties of the cured composition (“flame retardant monomer”).

6. A method of producing a flame-retardant translucent laminate according to claim 5, wherein the flame retardant monomer comprises pentabromobenzylacrylate, the reaction product of glycidyl methacrylate with dialkylphosphate, and/or the reaction product of glycidyl methacrylate with dialkylphosphate and boric acid.

7. A method of producing a flame-retardant translucent laminate according to claim 1, wherein the composition contains one or more monoethylenically or polyethylenically unsaturated monomers (“non flame retardant monomer”).

8. A method of producing a flame retardant translucent laminate according to claim 7, wherein the non flame retardant monomer comprises at least one of the following: acrylic acid, methacrylic acid, beta-carboxyethyl acrylate, butylacrylate, butylmethacrylate, methylacrylate, methylmethacrylate, 2-ethylhexylacrylate, 2-ethylhexylmethacrylate, acrylic acid, methacrylic acid, octyl/decyl acrylate, octyl/decyl methacrylate, 2-hydroxyethylacrylate, 2-hydroxyethylmethacrylate, phenoxyethylacrylate, phenoxyethylmethacrylate, nonylphenolethoxylate monoacrylate, nonylphenolethoxylate monomethacrylate, beta-carbonylethylacrylate, 2-(-2-ethoxyethoxy)ethylacrylate, 1,6-hexanediol diacrylate, pentaerythritoltriacrylate (PETIA), trimethylolpropanetriacrylate (TMPTA), acrylated or methacrylated oxyethylated or/and oxypropylated derivatives.

9. A method of producing a flame retardant translucent laminate according to claim 1, wherein the composition comprises an additive which is a not copolymerizable, non reactive, organic or inorganic compound contributing to the flame-retardant properties of the cured composition (“flame retardant additive”).

10. A method of producing a flame retardant light-transmitting laminate according to claim 9, wherein an intumescent agent and/or nanoparticles are used as flame retardant additive.

11. A method of producing a flame retardant laminate according to claim 1, wherein the composition comprises nanoparticles functionalized with acrylate and/or methacrylate functions.

12. A flame-retardant light-transmitting laminate obtainable by a method according to claim 1.

13. Radiation curable composition comprising:
(i) at least one radiation curable polymer precursor providing flame retardant properties to the cured composition (“flame retardant polymer precursor”), which polymer precursor comprises one or more radiation polymerizable, halogen or phosphorus containing (or combination of both) polymer precursor which have, at the chains ends or laterally along the chain, acrylic, methacrylic or vinyl groups, and
(ii) at least one of the following compounds:
(ii1) a radiation curable monomer which is a monoethylenically or polyethylenically unsaturated monomer (“non flame retardant monomer”) and/or
(ii2) a radiation curable monomer which is an halogen or phosphorus containing (or combination of both) reactive monomer which contributes to flame retardant properties of the cured composition (“flame retardant monomer”).

14. Radiation curable composition according to claim 13, wherein the flame retardant polymer precursor comprises at least one of: phosphorus containing urethane acrylate or methacrylate, phosphorus containing polyester acrylate or methacrylate, water-thinnable phosphorous-containing polyesteracrylate or methacrylate.

15. Radiation curable composition according to claim 13, wherein the non flame retardant monomer comprises at least one of the following: acrylic acid, methacrylic acid, beta-carboxyethyl acrylate, butylacrylate, butylmethacrylate, methylacrylate, methylmethacrylate, 2-ethylhexylacrylate, 2-ethylhexylmethacrylate, acrylic acid, methacrylic acid, octyl/decyl acrylate, octyl/decyl methacrylate, 2-hydroxyethylacrylate, 2-hydroxyethylmethacrylate, phenoxyethylacrylate, phenoxyethylmethacrylate, nonylphenolethoxylate monoacrylate, nonylphenolethoxylate monomethacrylate, beta-carbonylethylacrylate, 2-(-2-ethoxyethoxy)ethylacrylate, 1,6-hexanediol diacrylate pentaerythritoltriacrylate (PETIA), trimethylolpropanetriacrylate (TMPTA), acrylated or methacrylated oxyethylated or/and oxypropylated derivatives.

16. Radiation curable composition according to claim 13, wherein the flame retardant polymer precursor comprises at least one of: phosphorus containing urethane acrylate or methacrylate, phosphorus containing polyester acrylate or methacrylate, phosphorus containing epoxy acrylate or methacrylate.

17. Radiation curable composition according to claim 13, wherein the flame retardant polymer precursor comprises 9,10-dihydro-9-oxa-10-phosphaphenanthrene-10-oxide.

18. Radiation curable composition according to claim 13, wherein the flame retardant monomer comprises at least one of: pentabromobenzylacrylate, the reaction product of glycidyl methacrylate with dialkylphosphate, the reaction product of glycidyl methacrylate with dialkylphosphate and boric acid.

19. Radiation curable composition according to claim 13 wherein the composition is translucent.

20. Composition obtainable by radiation curing of the composition claimed in claim 13.

21. Composition according to claim 20, which is translucent.
